(19) United States
(12) Patent Application Publication
(10) Pub. No.: US 2012/0169056 A1
(43) Pub. Date: Jul. 5, 2012

(54) SYSTEM AND METHOD FOR ENERGY GENERATION

(76) Inventor: David L. PEED, Dahlonega, GA (US)

(21) Appl. No.: 13/421,224

(22) Filed: Mar. 15, 2012

Related U.S. Application Data
(63) Continuation of application No. PCT/US10/48859, filed on Sep. 15, 2010.
(60) Provisional application No. 61/242,938, filed on Sep. 16, 2009.

(51) Int. Cl. F03B 13/22

(52) U.S. Cl. 290/53

(57) ABSTRACT

A system and method for generating electrical power from water waves includes a ship-mounted or structure-mounted wave amplification channel with a multiple permanent anchoring system, one or more radially expandable wave wheels paired with expandable transitional push walls, and a chain drive assembly and automated means to accommodate varying ocean conditions.

### CROSS-REFERENCE TO RELATED APPLICATION

This application is a continuation of International PCT Patent Application Serial No. PCT/US10/48859 filed on Sep. 15, 2010, which claims priority benefit to U.S. Provisional Patent Application Ser. No. 61/242,938 filed Sep. 16, 2009, the entireties of which are hereby incorporated herein by reference.

### TECHNICAL FIELD

The present invention relates generally to the field of energy generation or conversion, and more particularly to a system and method for converting the rotational and transitional mechanical energy of water waves into useable electrical power.

### BACKGROUND

The production of energy from renewable resources can assist many societal needs, including reduction of dependence on hydrocarbon fuels, improved environmental conditions, and sustainability. The electricity produced by this method can not only be used to contribute to an existing on-shore grid, but also for desalinization of ocean water and/or the production of hydrogen and oxygen from sea water. It is to the provision of systems and methods of generating electrical power that the present invention is primarily directed.

### SUMMARY

In example embodiments, the present invention relates to the generation of electrical energy by conversion of wave energy in oceans. A first embodiment is a method for generating electrical power from water waves comprising rotational and transitional motion. This method includes guiding at least one water wave through an energy collection mechanism secured within a channel defined by two walls. The energy collection mechanism faces perpendicularly to the wave motion. This method also includes effecting a forward and circular motion of at least one wheel coupled with respect to an interior passageway in the energy collection mechanism. The forward and circular motion of the at least one wheel is effected by the rotational and circular motion of the at least one water wave. This method also includes converting the forward and circular motion of the at least one wheel into electrical energy with an energy converter and storing the converted energy in an energy storage device secured with respect to the at least one wheel.

A second example embodiment is a system for adapting a buoyant structure to varying water wave conditions. The system has at least one cable anchored to the ocean floor and secured within a rotating tensioner mounted to the buoyant structure. And, the system has at least one telescoping piston secured to the buoyant structure and extending to the ocean floor.

A third example embodiment is a water wave wheel for contacting a water wave having a variable amplitude. This water wheel includes a circular axis and a plurality of extendable paddles extending outwardly from the circular axis. And, the length of each retractably extendable paddle adjusts with respect to the amplitude of a water wave.

A fourth example embodiment is a system for enhancing water wave amplitude. The system includes a pair of buoyant guiding walls angled toward each other at an end of each wall and a plurality of anchors secured to the ocean floor. The system also includes a plurality of cables secured to the anchors and a plurality of rotors secured with respect to the buoyant guiding walls. And the cables are rotatably secured around the rotors.

A fifth example is a method for capturing energy from water waves comprising rotational and transitional motion and variable amplitude. This method includes providing a pair of buoyant guide walls comprising an energy collection mechanism secured between the buoyant guide walls and angling the buoyant guide walls so that the energy collection mechanism perpendicularly faces oncoming water waves. This method also includes securing the pair of buoyant guide walls to the ocean floor with a plurality of cables and supporting the pair of buoyant guide walls with a plurality of telescoping pistons extending from the buoyant guide walls to the ocean floor. And, this method includes ensuring that the guide walls extend below a trough line of the water waves.

The invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 shows momentum vectors of water motion near the surface in deep water ocean waves.

FIG. 2 is an illustration of the superposition principle of water waves.

FIG. 3 shows the multiple anchoring system used not only to take advantage of the superposition principle in harnessing wave energy but also to harness tidal energy.

FIG. 4 is a top view of the vessel showing its basic shape and the placement of many of the invention's parts.

FIG. 5 is a side view of the general construction of the wave energy collection mechanism between the ship hulls 1A and 1B.

FIG. 6 shows how the rotational chains 10A and 10B engage with a wave wheel assembly 2, via a pair of ratcheted rotational sprockets 4A and 4B, as it reenters the water.

FIG. 7 is used to describe how the system is automated to accommodate for varying ocean conditions.

FIG. 8 shows a wave wheel 2 and its paired wave walls 20 being pushed and rotated by a wave thus driving the machinery of the system.

FIG. 9 shows the basic construction of a wave wheel assembly 2 and the ratcheted sprockets 4A and 4B.

FIG. 10 shows the basic construction of a set of transitional push walls 20.

FIG. 11 shows the construction of the transitional chain locking mechanisms 3A and 3B.

FIG. 12 is an exploded view of both a rotational idler axle assembly 8, and the rotational transmission drive axle assembly 21.

FIG. 13 shows exploded views of part assemblies for both the end idler axles 5A and 5B and the top idler axles 7A and 7B.

FIG. 14 shows exploded views of part assemblies 6A and 6B; the bottom sets of idler axles.

FIG. 15 shows exploded views the transitional drive axle assemblies 26A and 26B.

FIG. 16 is a top view of the vessel and oncoming waves showing the relative locations of sensors 18A, 18B, 19A, 19B, 32A, 32B, 33A and 33B and electric magnets 12A, 12B, 27A and 27B.

FIG. 17 also shows the relative positions of sensors 18A, 18B, 19A, 19B, 32A, 32B, 33A and 33B and electric magnets 12A, 12B, 27A and 27B to the ship hulls 1A and 1B, from a side view with a close up.

FIG. 18 shows the details of the sliding walls 22A and 22B that connect the wave energy collection mechanism to the ship hulls 1A and 1B and to the transmissions to the electric generators housed within.

FIG. 19 shows a further shape and positioning of a push wall 29.

FIG. 20 shows an alternative design concept with a second narrower wave wheel 30 incorporated into a push wall 30.

FIG. 21 shows a third design possibility with the original wave wheel 2 absent.

FIG. 22 shows internal parts of the wave wheel 2 and the push wall 20 that enable expansion and contraction.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

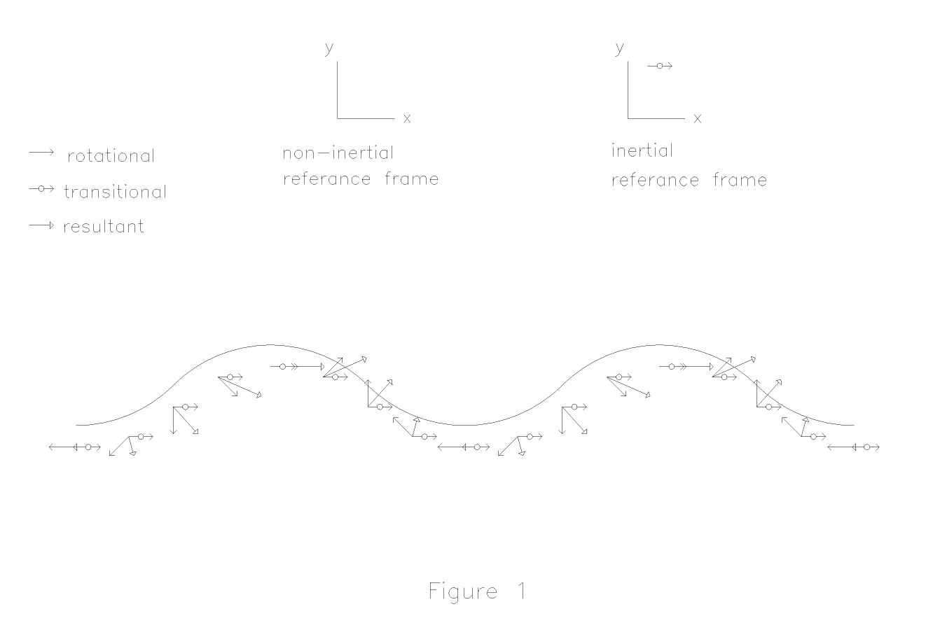

The present invention relates to a system and method for converting the rotational and transitional mechanical energy (illustrated in FIG. 1) of water waves into useable electrical power. Additional sources of mechanical power, most notably tidal power, will also be harnessed and processed when appropriate.

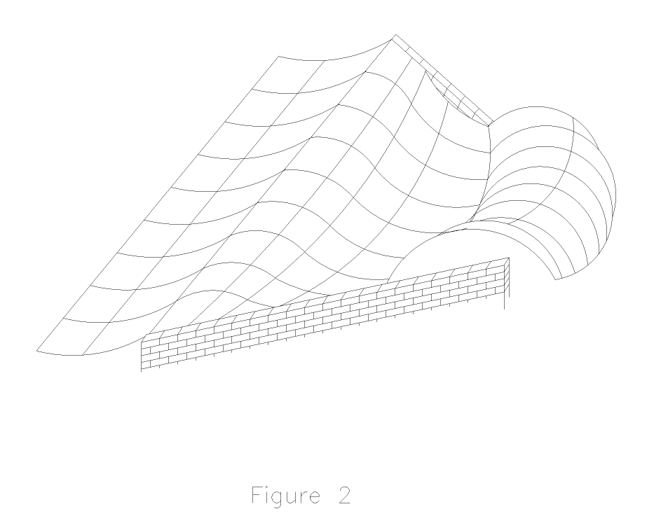

With this device it is advantageous to guide a mass of water above a trough line through a narrowed area to increase the size of the waves (FIG. 2). Assuming that the wave approaches the narrowing walls and opening in a straight line, the parts of the wave that are guided at an angle can travel a slightly greater distance. This can make the guided sections of the wave slightly out of phase and behind the un-deflected central part of each wave. The result can not only be greater wave amplitude, but also a broader wave. The lengths and angles of the wave walls can determine what will be limiting factors. As walls in FIG. 2 are lengthened, for example, the resulting superimposed wave can become broader and less clearly defined. An ideal wall length and angle can be determined by experiment to produce the most mechanically desirable wave for the parameters of a particular system.

This idea for enhancing the size of the wave is based on the superposition principle: If two or more waves are moving through a medium, the resulting wave function at any point is the algebraic sum of the wave functions of the individual waves. This idea is illustrated in FIG. 2.

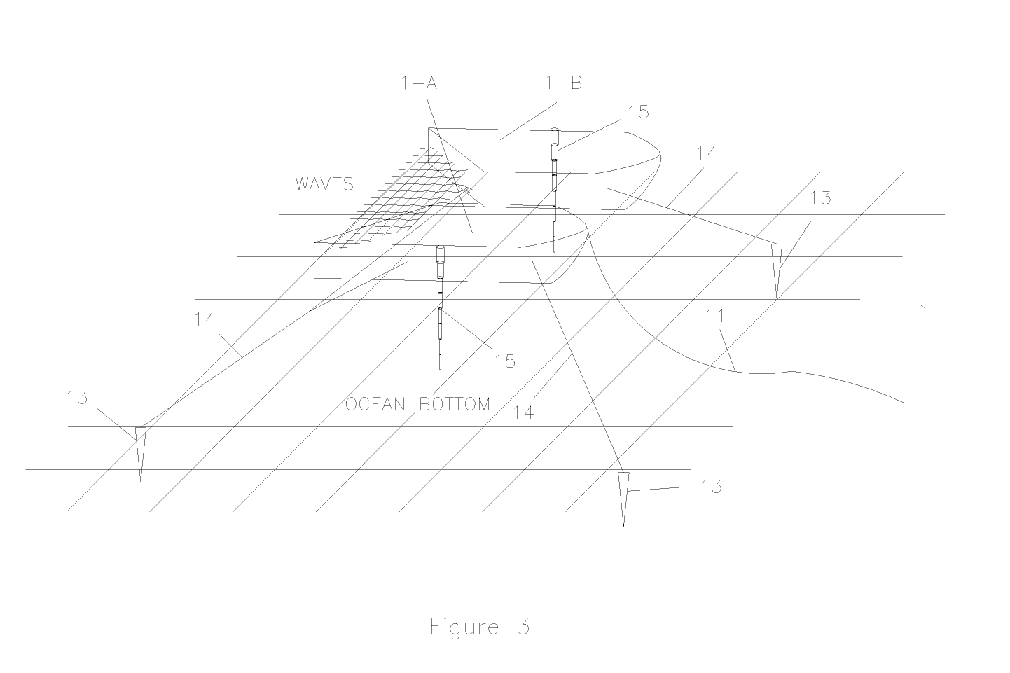

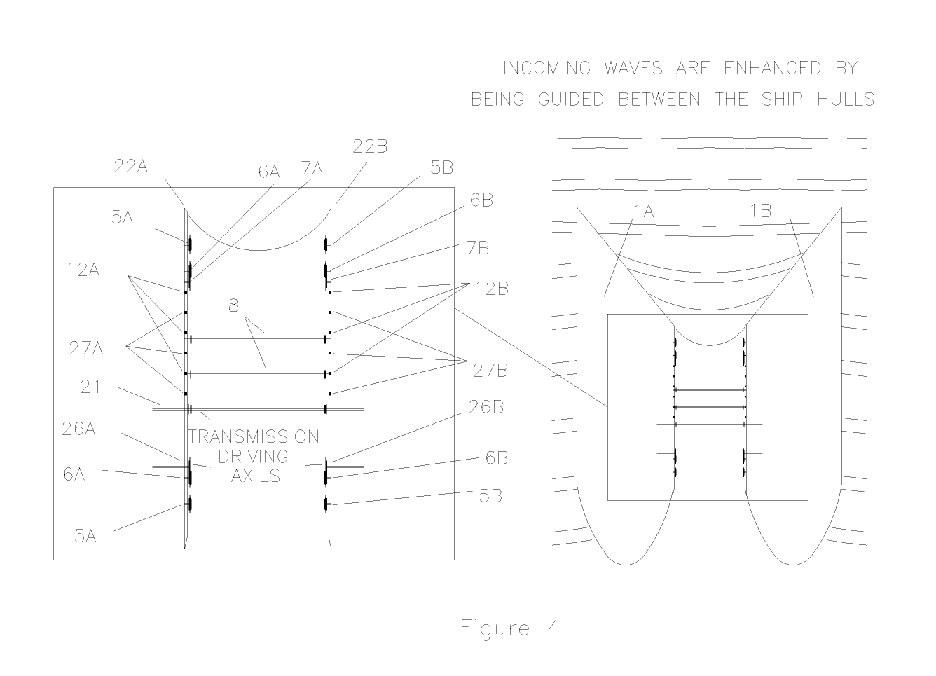

These guiding walls are not required to be built from the ocean floor. They can be the inside hull walls of a double hulled ship FIGS. 3 and 4 or similarly designed waterborne vessel. Multiple anchors 13 can hold the vessel in place. These anchors can maintain a fixed position while enduring tremendous tension on the anchoring cables 14. Because of this, in example embodiments the anchors 13 can be drilled into the ocean floor and be of a permanent nature. Once the anchoring cables 14 are attached to the permanent anchors 13 the tension in the anchoring cables 14 can be increased by mechanical means. This can help make the entire vessel and its inside hull walls guide the incoming waves through a narrowing channel as opposed to riding over the waves.

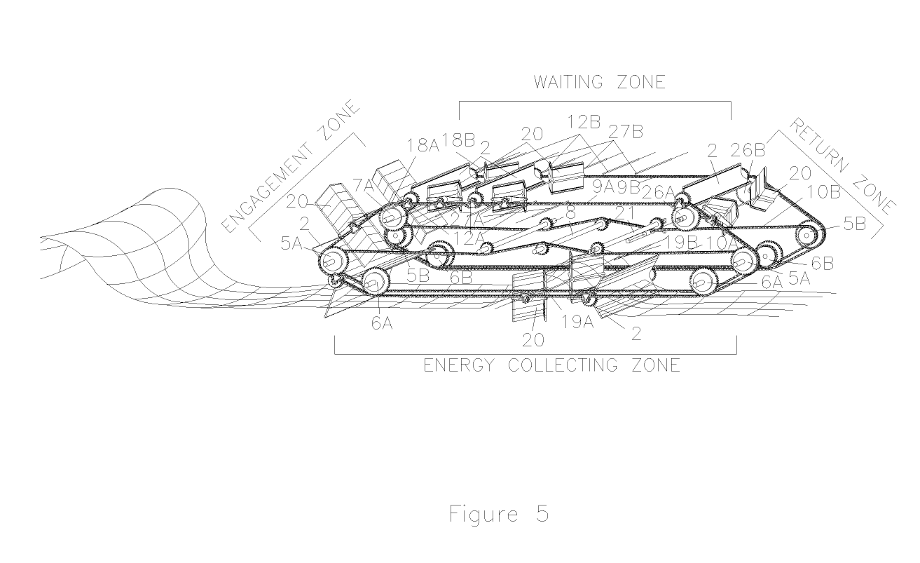

The wave energy collection device FIG. 5 can be mounted between the ship hulls 1A and 1B. The energy of any rocking forces to the entire vessel caused by waves thus increasing tension in the anchoring cables 14, can be captured though a transmission to drive electric generators within the ship hulls 1A and 1B. Each anchoring cable 14 can be attached to a transmission to drive electric generators. Any rise in tide, lifting the buoyant vessel against gravity can also be harnessed through the tension in the cables 14 to drive the generators by the system.

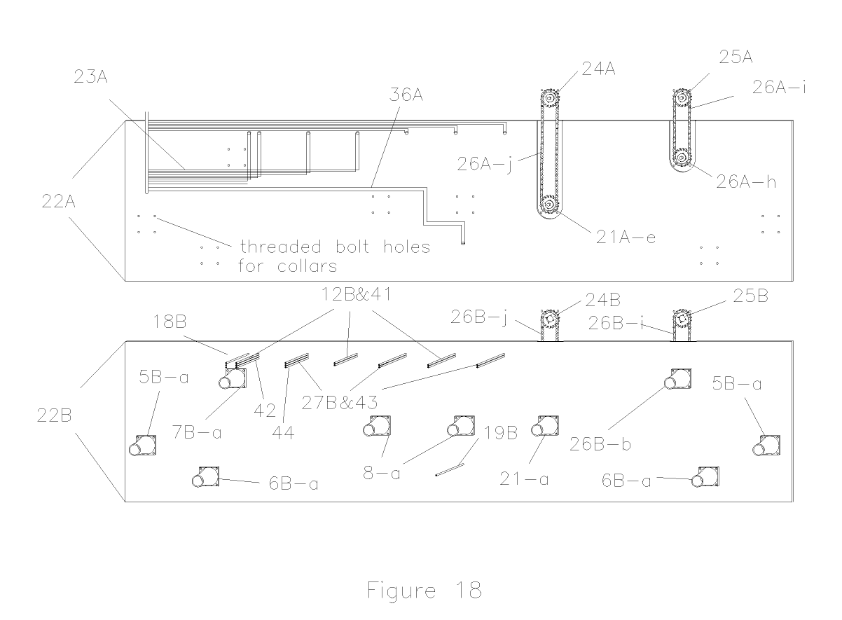

The wave energy collection mechanism FIG. 5 can be raised above the water line for transport. All of the machinery shown in FIG. 5 can be held together by two sliding walls 22A and 22B mounted between the ship hulls FIG. 18. Although they are not shown in the drawings, the two sliding walls 22A and 22B can be attached together by at least 2 rigid cross members. The ship hulls 1A and 1B can also be connected by at least 2 rigid cross members. All of these cross members can of course be placed as to not interfere with the motion of machinery.

Cranes fixed to the ship deck can be used to raise and lower the walls 22A and 22B and machinery as needed for transport. The drilled in permanent anchors 13 can be reused and located at several locations on the bottom of the ocean. If the generated electricity were sent to shore via undersea cable 11, the cable can also be left and reused at the specified location. This can allow the vessel to go to the location where conditions are best for generating electricity and to avoid potentially dangerous storms. If the electricity is being generated to supply an on shore grid, the permanent anchor 13 locations can also require an electric cable 11 running to the shore on the bottom of the ocean in place to be attached to that location.

### PART NUMBER INDEX FOR FIGS. 3,4 AND 5

1-A & 1-B Ship Hulls
2 Wave Wheel Assemblies
3-A & 3-B Transitional Chain Lock Mechanisms
4-A & 4-B Wave Wheel Rotational Chain Drive Sprockets
5-A & 5-B End Idler Axle and Sprocket Assemblies
6-A & 6-B Bottom Idler Axle and Sprocket Assemblies
7-A & 7-B Top Idler Shaft and Sprocket Assemblies
8 Rotational Axle and Sprocket Assemblies
9-A & 9-B Transitional Chains
10-A & 10-B Rotational Chains
11 Undersea Electric Transfer Cable to shore
12A & 12B Magnetic Brake for Wave Wheels
13 Permanent Anchors (drilled into ocean floor)
14 Anchoring Cables
15 Telescoping Hydraulic Receding Tide Energy Collector
16 Rotational Wave Wheel Roller
17 Transitional Wave Wheel Roller
18A and 18B Wave Wheel Sensor for Location D
19A & 19B Wave Wheel Sensor for Location C
20 Transitional Push Walls Assembly
21 Rotational Transmission Drive Axle Assembly
26 Transitional Transmission Drive Axle Assembly
27A and 27B Magnetic Brakes of Pushing Walls

Although no dimensions are given in this document, one of ordinary skill ordinarily would recognize that as the scale of the device increases, the energy-generating potential increases exponentially. Volume, mass, and thus energy collected increase to the third power as the scale of the device and the waves increase. In addition to this, bigger waves are also faster moving and rolling waves. Kinetic energy increases to the second power with velocity.

The displacement of the vessel can be relatively small due to the rise and fall of the tide. The tension on the anchoring cables as the tide rises buoying the vessel upward can be tremendous. The anchoring cables can be attached to a transmission to rotate electric generators. If passing through the ship hulls below the water line the hole for the anchoring cable can be water-tight also allowing the cable to be pulled under great tension and recoiled. The anchoring cables can be attached to the transmissions above the waterline through the ship hulls or on the deck of the ship.

As the tide lowers, the vessel can be lowered closer to the bottom of the ocean. The energy exerted by gravity on the mass of the ship can be captured by hydraulic pistons 15A and 15B inside interlocking parts that extend to the bottom of the ocean like an extendable telescope (see FIG. 3). As the weight of the vessel compresses the pistons inside the interlocking parts, the resulting increased pressure of the hydraulic fluid can be transmitted by known conventional means to spin electric generators.

In each transmission in this device, very substantial torques can be exchanged for appropriate angular velocities to rotate the generators inside the ship hulls 1A and 1B.

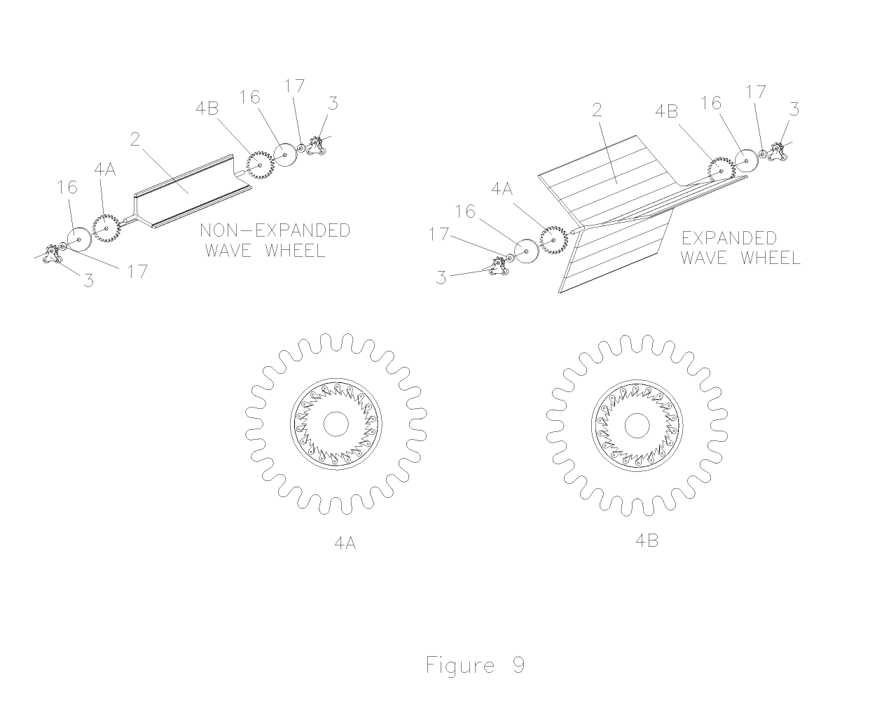

The wave energy collection device FIG. 5 can be used for the conversion of the kinetic energy of the channeled waves into electricity. An example mechanism to capture and convert the energy of the waves can be facing perpendicular to the natural circular and forward motion of the waves. A three edged wave wheel 2, damped and harnessed in both a rotational and forward manner placed broadside in the wave path, can be utilized in example forms of the invention. Regardless of its rotational orientation, a three-paddled wheel 2 can be pushed to motion by each wave. Any greater number might redirect the natural momentum of the water FIG. 9.

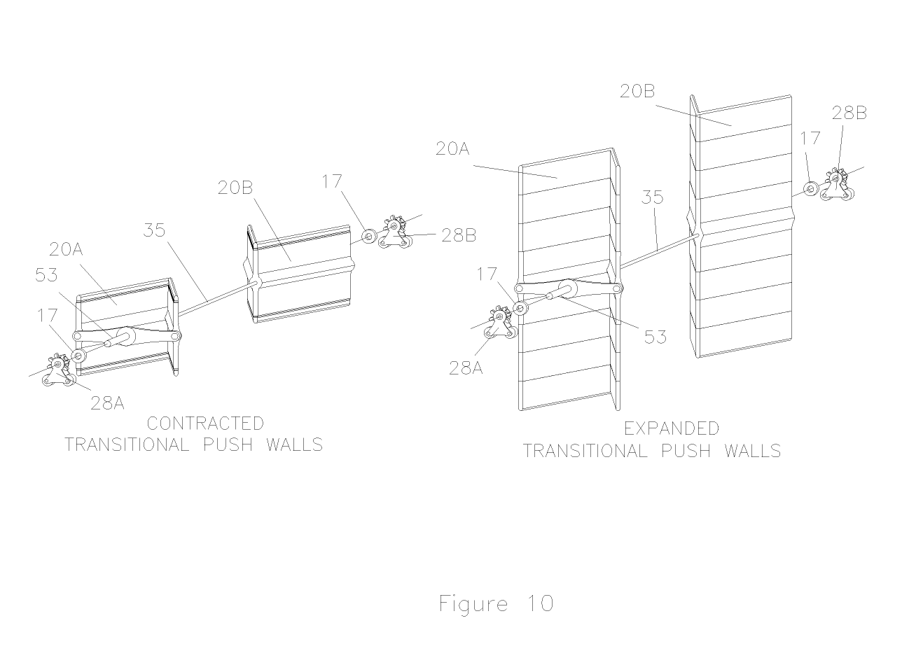

### PART NUMBER INDEX FOR FIGS. 9 AND 10

2 Wave Wheel
3 Transitional Chain Lock Mechanism for Wave Wheels 2
4A and 4B Ratcheted Wave Wheel Sprocket
16 Wave Wheel Bypass Roller
17 Transitional Roller for Wave Wheel 2 and Push Walls 20
20A and 20B Transitional Push Walls
28A and 28B Transitional Chain Lock Mechanism for Push Walls 20
35 Connecting Rod
52 Axle for Wave Wheel
53 Axels for Push Walls

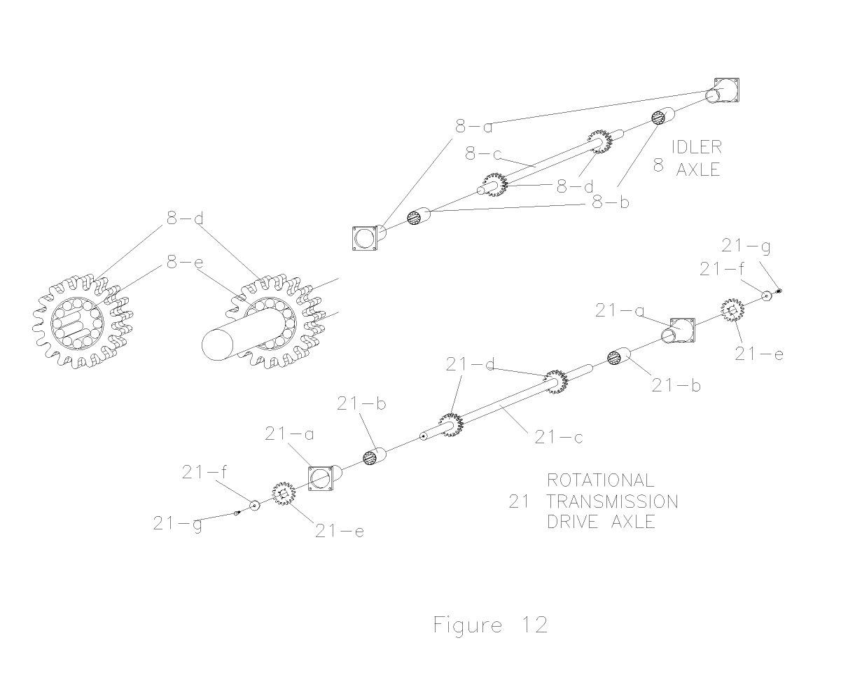

### PART NUMBER INDEX FOR FIG. 12

8 Rotational Idler Axle Assembly
8-a Collars to Sliding Walls 22A and 22B (see FIG. 18)
8-b Roller Bearing Assemblies
8-c Rotational Idler Axle
8-d Double Rotational Chain Sprocket
8-e Double Rotational Chain Sprocket Roller Bearing Assembly
21 Rotational Transmission Drive Axle Assembly
21-a Collars To Sliding Walls 22A and 22B
21-b Roller Bearing Assemblies
21-c Rotational Drive Axle
21-d Double Rotational Chain Sprockets
21-e Lower Rotational Transmission Sprocket
21-f Retention Plate
21-g Bolt

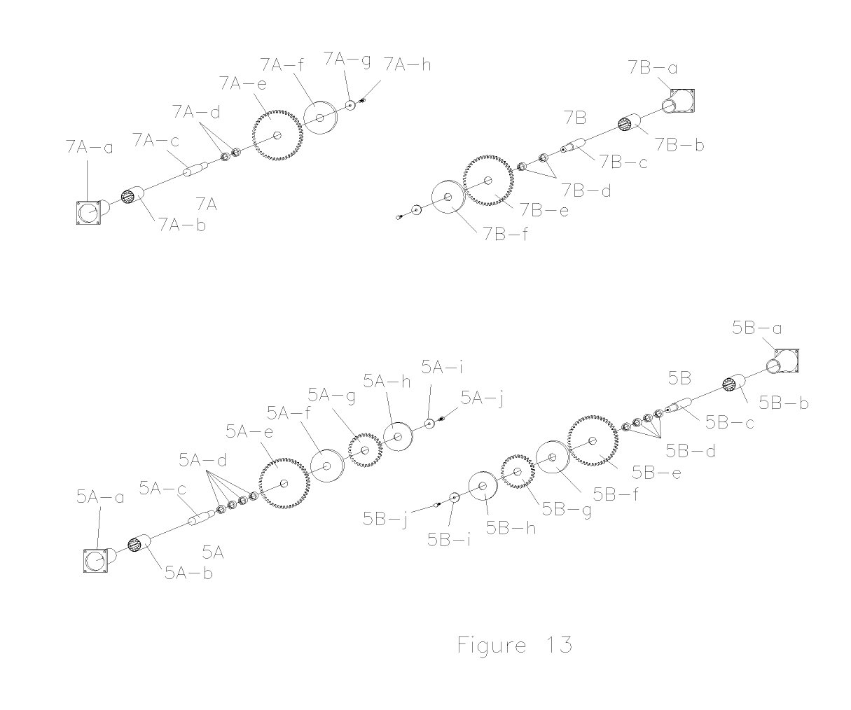

### PART NUMBER LIST FOR FIG. 13

5A and 5B End Idler Axle Assemblies
5A-a and 5B-a Collars to Sliding Walls 22A and 22B
5A-b and 5B-b Collar Roller Bearing Assemblies
5A-c and 5B-c End Idler Axles
5A-d and 5B-d Roller Bearing Assemblies
5A-e and 5B-e End Transitional Chain 9A and 9B Sprockets
5A-f and 5B-f End Chain Locking Mechanism 3A and 3B Bypass Rollers
5A-g and 5B-g End Rotational Sprockets
5A-h and 5B-h End Rotational Chain 10A and 10B Rollers
5A-l and 5B-l Retention Plates
5A-j and 5B-j Bolts
7A and 7B Top Idler Axle Assemblies
7A-a and 7B-a Collars to Sliding Walls 22A and 22B
7A-b and 7B-b Collar Roller Bearing Assemblies
7A-c and 7B-c Top Idler Axles
7A-d and 7B-d Roller Bearing Assemblies
7A-e and 7B-e Top Transitional Chain 9A and 9B Sprockets
7A-f and 7B-f Top Chain Locking Mechanism 3A and 3B Bypass Rollers
7A-g and 7B-g Retention Plates
7A-h and 7B-h Bolts

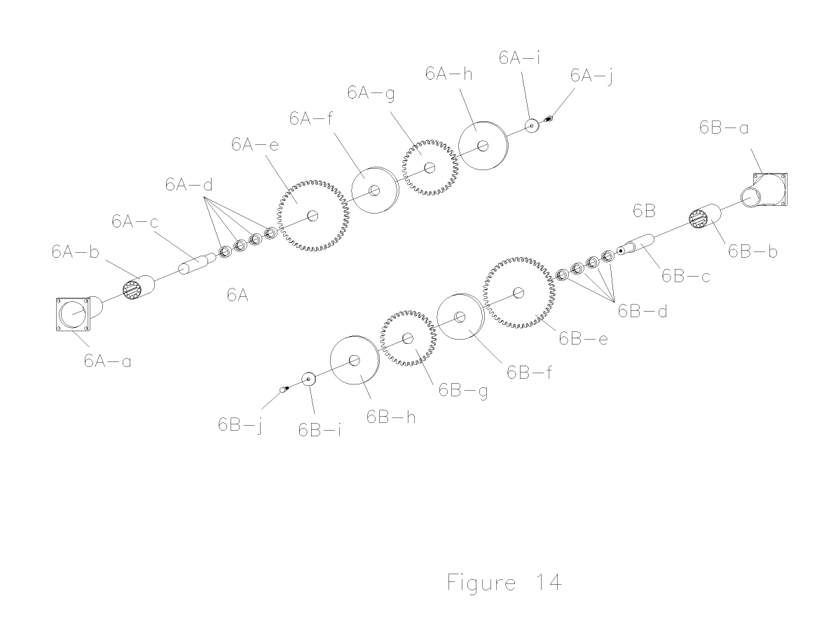

### PARTS INDEX FOR FIG. 14

6A and 6B Bottom Idler Axle Assemblies
6A-a and 6B-a Collars to Sliding Walls 22A and 22B
6A-b and 6B-b Collar Roller Bearing Assemblies
6A-c and 6B-c Bottom Idler Axle
6A-d and 6B-d Roller Bearing Assemblies
6A-e and 6B-e Bottom Transitional Chain 9A and 9B Sprockets
6A-f and 6B-f Bottom Chain Locking Mechanism 3A and 3B Bypass Rollers
6A-g and 6B-g Bottom Rotational Chain 10A and 10B Sprockets
6A-h and 6B-h Bottom Rotational Chain 10A and 10B Rollers
6A-i and 6B-i Retention Plates
6A-j and 6B-j Bolts

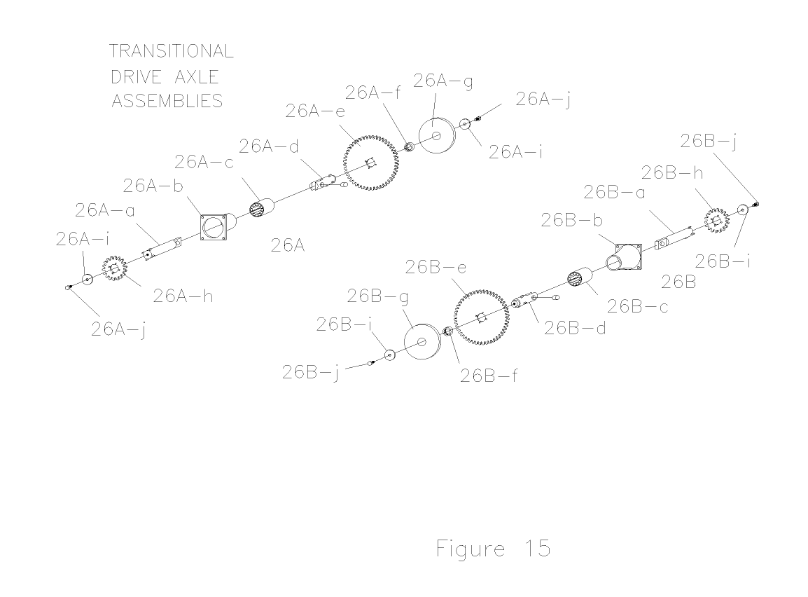

### PARTS INDEX FOR FIG. 15

26A and 26B Transitional Drive Axle Assemblies
26A-a and 26B-a Transitional Transmission Drive Axles
26A-b and 26B-b Collars to Sliding Walls 22A and 22B
26A-c and 26B-c Collar Roller Bearing Assemblies
26A-d and 26B-d Transitional Drive Axles and Pins
26A-e and 26B-e Transitional Chain Drive Sprockets
26A-f and 26B-f Roller Bearing Assemblies
26A-g and 26B-g Chain Lock Mechanism Bypass Rollers
26A-h and 26B-h Upper Transitional Transmission Drive Sprockets
26A-i and 26B-l Retainer Plates
26A-j and 26B-j Bolts

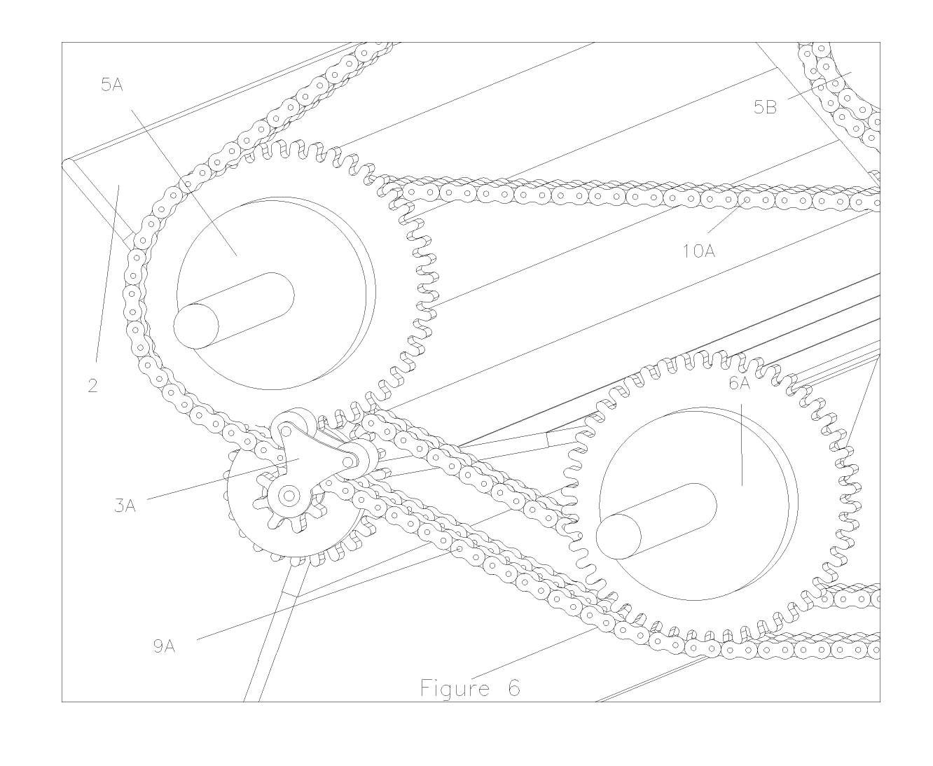

Several wave wheels 2 alternating with pairs of transitional pushing walls 20 can be attached to a pair of transitional chains 9A and 9B mounted on sprockets 26A-e, 26B-e, 6A-e, 6B-e, 7A-e, 7B-e, 5A-e and 5B-e between the ship hulls 1A and 1B (see FIGS. 4 and 5). Each wave wheel 2, along with the pair of transitional pushing walls 20 that follow it can collectively be called a “wheel-walls set” 2 and 20. The transitional chains 9A and 9B can remain in motion like a conveyor belt as long as at least one wave is passing along their length, and can be driven by waves pushing upon wheel-walls sets 2 and 20. The wheel-walls set 2 and 20 axles can usually be rigidly attached to the transitional chains 9A and 9B as to drive or be driven by the chains 9A and 9B. While in the waiting zone the wheel-walls sets 2 and 20 can be fully contracted and remain in place, being held by pairs of magnetic brakes 12A, 12B, 27A and 27B. While being held stationary, these wheel-walls sets 2 and 20 can not be rigidly attached to the chains 9A and 9B, allowing their links to move freely past. The wheel-walls set 2 and 20 to the farthest left on the top of the transition chains 9A and 9B in FIG. 5 can be referred to as the “next waiting set” 2 and 20. Each time an approaching wave is detected, the magnetic brakes 12A, 12B, 27A and 27B can turn off momentarily, allowing the next waiting set 2 and 20 to be pulled into the engagement zone by the transitional chains 9A and 9B. Other waiting sets 2 and 20 can move with the transitional chains 9A and 9B, each to the next two pairs of magnets 12A, 12B, 27A and 27B, thus creating a new “next waiting set” 2 and 20. Each wheel-walls set 2 and 20 is released in time into the engagement zone to meet the water surface in the trough in front of the next wave. While moving through the engagement zone the pushing walls 20 and paddles of each wheel 2 can expand to match the amplitude of the wave they are paired with. As each wheel 2 is overtaken by its paired wave, it also engages with a pair of rotational chains 10A and 10B via a pair of sprockets 4A and 4B on each wave wheel assembly 2 (see FIG. 6). While moving through the energy collection zone the wheel walls sets 2 and 20 harness both the rotational and transitional motion of the waves driving all of the chains 9A, 9B, 10A, 10B, 26A-l, 26B-l, 26A-j and 26B-j. The paddles of each wheel 2 and pair of walls 20 can retract towards the center as the energy and amplitude of the wave is taken pushing the walls 20 and turning the wheel 2. Entering the return zone, each wave wheel 2 disengages from the rotational chains 10A and 10B and is driven by the transitional chains 9A and 9B. If any further retraction is needed it can be completed in the return zone. In the waiting zone each wheel-walls pair 2 and 20 waits its turn in sequence until it becomes the next waiting set 2 and 20 and the cycle continues. Thus far this is a general overview. Further details of the wave energy collection device is explained below.

Both sets of chains described above 9A, 9B, 10A and 10B can be mounted upon sprockets 26A-e, 26B-e, 6A-e, 6B-e, 7A-e, 7B-e, 5A-e, 5B-e, 8-d, 21-d, 5A-g, 5B-g, 6A-g and 6B-g as shown in FIG. 5. All of these sprockets 26A-e, 26B-e, 6A-e, 6B-e, 7A-e, 7B-e, 5A-e, 5B-e, 8-d, 21-d, 5A-g, 5B-g, 6A-g and 6B-g can be mounted on axles 26A-d, 26B-d, 6A-c, 6B-c, 7A-c, 7B-c, 5A-c, 5B-c, 8-c and 21-c. A top view of the arrangement without the chains 9A, 9B, 10A and 10B shown is depicted in FIG. 4. Note that these axles 26A-d, 26B-d, 6A-c, 6B-c, 7A-c, 7B-c, 5A-c, 5B-c, 8-c and 21-c all extend into collars 5A-a, 5B-a, 6A-a, 6B-a, 7A-a, 7B-a, 8-a, 21-a, 26A-b and 26B-b mounted on the sliding walls 22A and 22B (see FIG. 18). These sliding walls 22-A and 22-B can be fitted to the inside wall of the ship hulls 1-A and 1-B. All of the idler sprockets 8-d, 6A-e, 6B-e, 7A-e, 7B-e, 5A-e, 5B-e, 5A-g, 5B-g, 6A-g and 6B-g can be attached to an axle 8-c, 6A-c, 6B-c, 7A-c, 7B-c, 5A-c and 5B-c via a roller bearing sleeve 8-d, 6A-d, 6B-d, 7A-d, 7B-d, 5A-d and 5B-d allowing them to turn freely (see FIGS. 12-15). In addition to these roller bearing sleeves 8-d, 6A-d, 6B-d, 7A-d, 7B-d, 5A-d and 5B-d on the idling sprockets 8-d, 6A-e, 6B-e, 7A-e, 7B-e, 5A-e, 5B-e, 5A-g, 5B-g, 6A-g and 6B-g, every axle 26A-d, 26B-d, 21-c, 8c, 6A-c, 6B-c, 7A-c, 7B-c, 5A-c and 5B-c is allowed to turn freely via roller bearing assemblies 8-b, 21-b, 7A-b, 7B-b, 5A-b, 5B-b, 6A-b, 6B-b, 26A-c and 26Bc inside the collars 5A-a, 5B-a, 6A-a, 6B-a, 7A-a, 7B-a, 8-a, 21-a, 26A-b, thus reducing friction to an even greater degree. On both sides A and B, axle assemblies 26A and 26B can be rigidly attached to sprockets 26A-e and 26B-e driven by the transitional chains 9A and 9B; also on both sides A and B, axle assembly 21 can be rigidly attached to sprockets 21-d driven by the rotational chains 10A and 10B. These axles 21-c, 26A-d, and 26B-d can serve to drive the transmissions inside the ship hulls 1A and 1B. These transmissions can likely incorporate energy storage and regulation in the form of a dense inertial ring in the drive train to the generators.

To accommodate both the natural variation in wave amplitude and the decreasing size of each wave as energy is drawn from it; the length of both the paddles of the wave wheels 2 and the pushing walls 20 can be made to vary accordingly (see FIGS. 9&10). They can be made to expand and contract to needed and most efficient dimensions by interlocking telescoping parts. These parts can be driven by electric, hydraulic or pneumatic means using solenoids, worm gears driven by electric motors, pistons or by the parts themselves acting as pistons. Each wave wheel 2, as well as each pair of pushing walls 20, can be expanded appropriately to fit the size of the wave with which the wheel-walls pair 2 and 20 is matched. As energy is drawn from the wave the wheel-walls pair 2 and 20 can contact through the energy-gathering zone as the wave size decreases.

Because they can move independently from the rest of the mechanism at large, each wave wheel 2, and each pair of pushing walls 20, can contain a means of energy storage to accommodate the expansion and contraction of the telescoping parts. Electrical energy can be stored in a battery inside of each wave wheel and pushing wall. Worm gears coupled to an electric motor or electric solenoids could drive the expansion or contraction of the interlocking parts. The batteries can be recharged during some point in the cycle by a recharging electrical connection. This recharging connection can exist in the return and/or waiting zones. It can move with or run alongside the path of the wheel-walls pairs 2 and 20 as they move. Recharging can also take place, as each wheel-walls pair 2 and 20 remains stationary at each set of two magnetic brake pairs 12A, 12B, 27A and 27B.

Energy can also be stored in each wheel-walls pair 2 and 20 by mechanical means in the form of a steel spring, or pair of springs. The springs can be rewound by the sprockets within the transition chain locking mechanisms 3A-d and 3B-d while in the waiting stationary positions. This can utilize not only a connecting shaft from sprocket 3A-d and 3B-d to spring, but also a release trigger to prevent over-winding. The release triggers can be designed like the head of a ratcheting torque wrench.

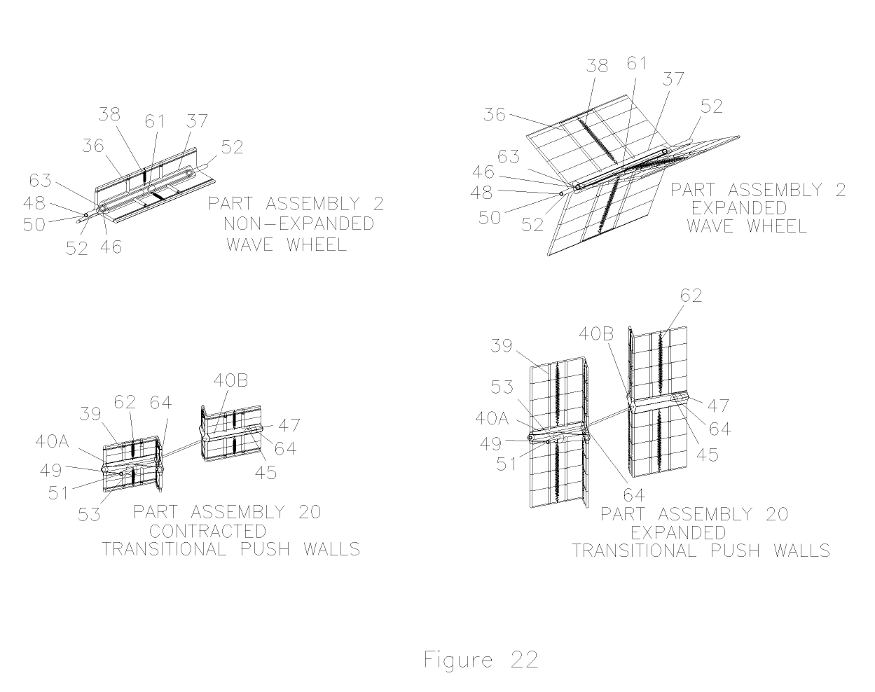

### PART NUMBER INDEX FOR FIG. 22

2 Wave Wheel
20 Transitional Push Walls
36 Pneumatic Pistons for Wave Wheel Paddles
37 Air Tank for Wave Wheel
38 Contraction Springs for Wave Wheel Paddles
39 Pneumatic Pistons for Push Walls
40A and 40B Air Tank for Push Walls
45 Electronic Circuit Board for Push Walls
46 Battery for Wave Wheel
47 Battery for Push Walls
48 Battery Recharge Connector on Wave Wheel
49 Battery Recharge Connection on Push Walls
50 Circuit Board Connection on Wave Wheel
51 Circuit Board Connection on Push Walls
52 Axle for Wave Wheel
53 Axles for Push Walls
61 Electronic Circuit Board for Wave Wheel
62 Contraction Springs for Push Walls
63 Air Compressor for Wave Wheels
64 Air Compressor for Push Walls

FIG. 22 shows a wave wheel 2 and a set of push walls 20 with internal parts shown required for extension and contraction. Whenever a wave wheel 2 or set of push walls 20 is being held by a magnetic brake in the waiting zone, its respective battery 46 or 47 can become recharged. The battery recharge connections 48 on each wave wheel 2 can extend electrically through the chain locking mechanisms 3A and 3B connect with the recharge station connections 41 at each magnetic brake 12A and 12B in the waiting zone FIG. 18, FIG. 22. The battery recharge connections 49A and 49B on each set of push walls 20 can extend electrically through the chain locking mechanisms 28A and 28B, and connect with the recharge station connections 43 at each magnetic brake 27A and 27B in the waiting zone. A voltage from the sensors 32A, 32B, 33A and 33B can be supplied to the circuit board 61 inside each wave wheel 2 through the connection of 50A and 50B to 53A and 53B. This voltage can determine the amount of expansion needed to match the wave wheel 2 to its paired wave. A voltage from the sensors 32A, 32B, 33A and 33B can be supplied to the circuit board 45 inside each set of push walls 20 through the connection of 51A and 51B to 54A and 54B. This voltage can determine the amount of expansion needed to match the set of push walls 20 to its paired wave. The circuit boards 61 and 45 can control the amount of compressed air allowed to pass from the tanks 37,40A and 40B into the pneumatic pistons 36 and 39 by electrical control of valves (not shown). The recompression of the pistons 36 and 39 can occur gradually though the energy collection zone FIG. 5 via the force in the springs 38 and 62. This can be through the partial opening of other pressure release valves (also not shown) and can be determined by pressure, location and time and be controlled by the circuit boards 61 and 45. In order to maintain radial symmetry and mass distribution in the wave wheels 2, the battery 46 and air compressor 63 can be of an unusual tubular shape surrounding the axle

A tank of compressed air inside of each wave wheel 2 and pushing wall 20, re-pressurized while in the waiting positions can also serve this purpose by driving pneumatic pistons.

Each wave wheel 2 and pushing walls pair 20 can be made of strong, non-corrosive material that is the same density as water. Neutral buoyancy can provide efficient rotation of the wave wheels 2 without a floating or sinking force in resistance.

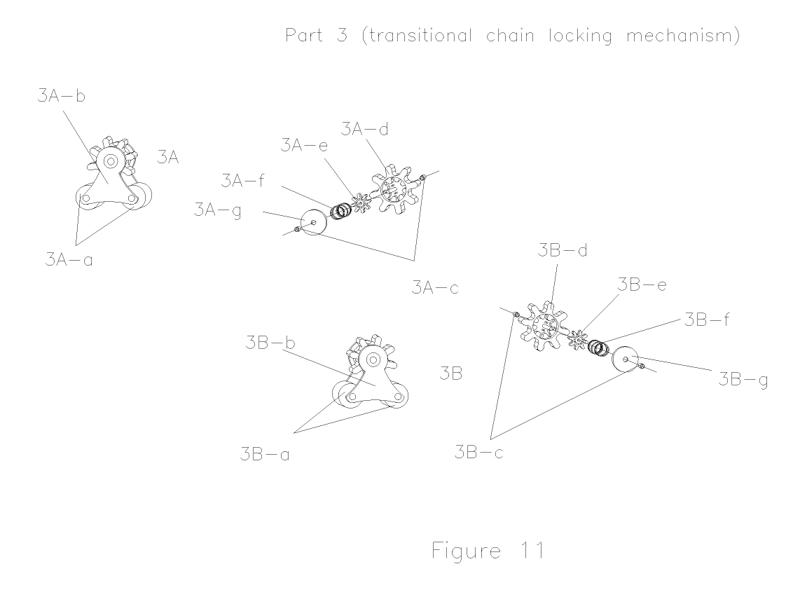

The wave wheel assemblies 2 and the push walls assemblies 20 can both have a transitional chain locking mechanisms 3A and 3B or 28A and 28B attaching them 2 and 20 to the transitional chains 9A and 9B. The parts of the transitional chain locking mechanisms 3A and 3B for the wave wheel assemblies 2 are shown in FIG. 11. The transitional chain locking mechanism 28A and 28B for the pairs of pushing walls 20 can be mechanically identical to part 3 shown in FIG. 11. 28A and 28B with differ from 3A and 3B only by the presence or absence of a reflective or ferrous material to be detected by sensors 18A, 18B, 19A and 19B, covered later in this document.

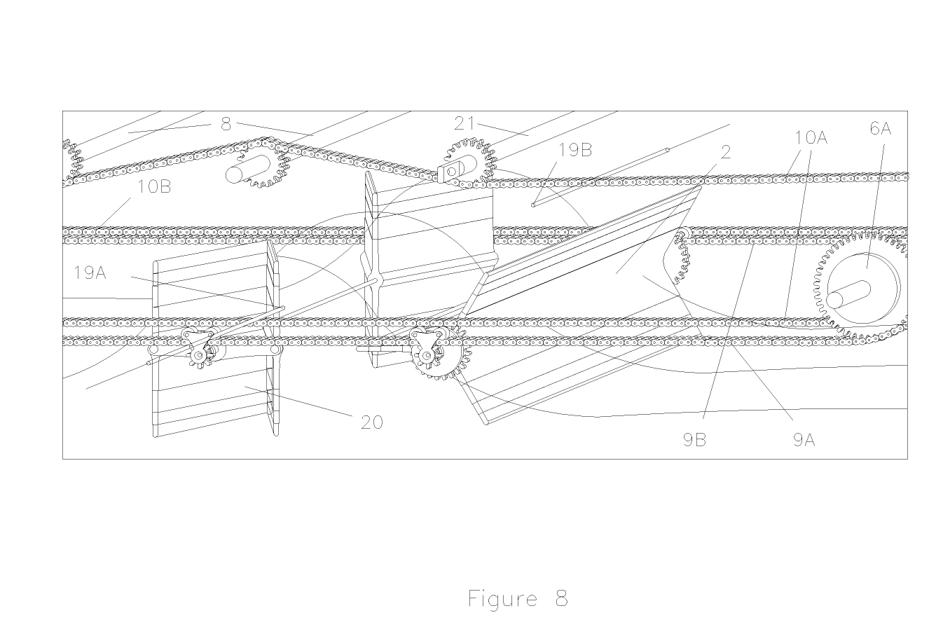

Mounted to each side of the axle of each wave wheel 2 and pushing wall pair 20 can be a transitional chain lock mechanism 3A, 3B, 28A and 28B (see FIG. 11). These mechanisms can include a sprocket 3A-d and 3B-d that could be locked onto the transitional chain 9A and 9B to drive or be driven by the chain 9A and 9B when needed. While in a locked position the wave wheel 2 can be made such that it can be free to rotate as it is locked to the transitional chains 9A and 9B. When in a waiting position, the sprocket 3A-d and 3B-d can turn freely. While in a stationary waiting position the links of the transitional chain 9A and 9B can pass freely through the mechanisms 3A and 3B. The locking and unlocking of these mechanisms can be controlled by a magnetic of brakes 12A, 12B, 27A and 27B. While a brake is engaged the sprocket 3A-d and 3B-d in the transitional chain locking mechanism 3 can turn freely. When a brake 12A, 12B, 27A and 27B is disengaged the sprocket 3A-d and 3B-d can lock onto and move with the transitional chain 9A and 9B (see FIGS. 5 through 11).

FIG. 11 shows the parts inside the transitional chain locking mechanism 3A and 3B.

### PART NUMBER INDEX FOR FIG. 11

3A-a & 3B-a chain roller and bearing assemblies
3A-b & 3B-b connector brackets
3A-c & 3B-c axle bearing assemblies
3A-d & 3B-d wave wheel to transitional chain sprocket
3A-e & 3B-e locking gear (target of magnets)
3A-f & 3B-f spring
3A-g & 3B-g spring retainer plate

Each side of the axle of each wave wheel 2 can also have a rotational wave wheel sprocket 4A and 4B mounted to it (see FIG. 9). These sprockets 4A and 4B can be ratcheted, one 4A clockwise and one 4B counterclockwise for each wheel such that they can be locked in the rotational direction of the waves to drive the rotational chains 9A and 9B. If another wave wheel 2 is driving the rotational chains 10A and 10B faster than another wave wheel 2, the rotational wave wheel sprockets 4A and 4B can ratchet backward to prevent binding.

### PARTS INDEX FOR FIG. 18

5B-a Collars for End Idler Axles 5B-c
6B-a Collars for Bottom Idler Axles 6B-c
7B-a Collar for Top Idler Axle 7B-b
8-a Collars for Idler Rotational Axles 8-c
12B Magnetic Brakes for Wave Wheels 2
18B B Side of Sensor D at Location D
19B B Side of Sensor C at Location C
21A Collar for Rotational Drive Axle 8-c
21A-e Lower Rotational Transmission Drive Sprocket for 1A
22A and 22B Vertically Sliding Walls attached to Ship Hulls 1A and 1B
23A Wiring Harness for Magnetic Brakes 12A and 27A
24A and 24B Upper Rotational Transmission Drive Sprockets
25A and 25B Upper Transitional Transmission Drive Sprockets
26A-h and 26B-h Lower Transitional Transmission Drive Sprockets
26A-l and 26B-l Transitional Transmission Drive Chains
26A-j and 26B-j Rotational Transmission Drive Chains
27B Magnetic Brakes for Push Walls 20
36A Wiring Harness for A Side of Sensor C 19A
40 Battery Recharge Connections for Wave Wheels
41 Sensory Voltage Connections for Wave Wheels
42 Battery Recharge Connections for Push Walls
43 Sensory Voltage Connections for Push Walls

The wave energy-collecting device can be mounted on two walls 22A and 22B (FIG. 18) between the ship hulls 1A and 1B as to take advantage of the channeled waves. Multiple axle assemblies 8, 21, 5A, 5B, 6A, 6B, 7A, 7B, 26A and 26B supporting the wave energy collection mechanism can be mounted between these walls. In addition to this at least two fixed cross members (not shown the drawings) connecting the sliding walls 22A and 22B can be needed to hold together the wave energy collection mechanism as it is raised and lowered. These sliding walls 22A and 22B can be raised for transport or lowered for use between the ship hulls 1A and 1B. The axle assemblies 8, 21, 5A, 5B, 6A, 6B, 7A, 7B, 26A and 26B are detailed in FIGS. 12 through 15. Three of these axle assemblies 21, 26A and 26B can be equipped to rotate the machinery of a transmission to drive electric generators inside the ship hulls 1A and 1B.

Sprockets 26A-e, 26B-e, 7A-f, 7B-f, 6A-e, 6B-e, 5A-e and 5B-e can be mounted on the axle assemblies 26A, 26B, 7A, 7B, 6A, 6B, 5A and 5B to accommodate a pair of double transitional chains 9A and 9B (see FIGS. 4,5,12-15 and 18) These sprockets 26A-e,26B-e,7A-f,7B-f,6A-e,6B-e,5A-e and 5B-e can be mounted to the sliding walls 22A and 22B, but do not extend into the range of motion of the wave wheels 2 or push walls 20. The axles 8-c and 21-c extending the span across from wall 22A to wall 22B, can be beyond or between the ranges of motion of the wave wheels 2 and push walls 20. A pair of double rotational chains 10A and 10B can be mounted to sprockets 21-d, 8-d, 5A-g, 5B-g, 6A-g and 6B-g. A top view of the axle assemblies 21, 8, 5A, 5B, 6A, 6B, 7A, 7B, 26A and 26B that the transitional 9A and 9B and rotational chains 10A and 10B can be mounted upon is shown in FIG. 4.

If made of steel, these chains 9A, 9B, 10A and 10B can be resistant to, or protected from, the corrosive ocean water. This can be achieved by a watertight protective housing that also allows the chains 9A, 9B, 10A and 10B and all other parts 21, 8, 5A, 5B, 6A, 6B, 7A, 7B, 26A, 26B, 2 and 20 to move freely. This housing can also serve to house and protect a reservoir of oil or some other lubricant. The chains 9A, 9B, 10A, 10B and other potentially exposed moving parts 21, 8, 5A, 5B, 6A, 6B, 7A, 7B, 26A, 26B, 2 and 20 can also be protected from ocean water by a plastic coating. The possibility also exists that the chains 9A,9B,10A and 10B and other exposed moving parts 21, 8, 5A, 5B, 6A, 6B, 7A, 7B, 26A, 26B, 2 and 20 be made of a strong non-corrosive material such as Kevlar, ABS plastic, stainless steel or titanium. Belts or cables can also be used in place of chains 9A, 9B, 10A and 10B if pulleys and other types of engagement and locking mechanisms were used in place of sprockets 26A-e, 26B-e, 7A-f, 7B-f, 6A-e, 6B-e, 5A-e and 5B-e. If chains 9A, 9B, 10A and 10B and sprockets 26A-e, 26B-e, 7A-f, 7B-f, 6A-e, 6B-e, 5A-e and 5B-e are used, the transitional chains 9A and 9B can be a pair of double chains and the rotational chains 10A and 10B can be a pair of double chains. Pairs can also use belts or cables.

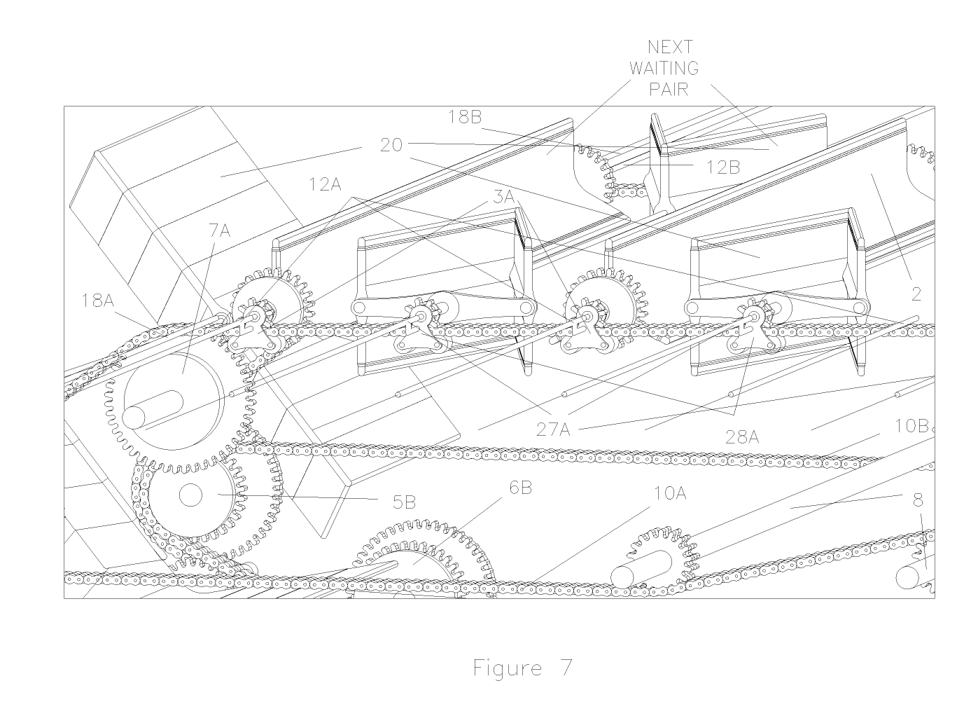

In FIG. 5 and FIG. 7, the next waiting pair 2 and 20 and the other wheel-wave pair 2 and 20 just to its right are in a waiting position. While in the waiting position the pair of electromagnetic brakes beside each wave wheel walls pair 2 and 20 are engaged on, and the transitional chain lock mechanisms 3A, 3B, 28A and 28B are unlocked FIG. 5, FIG. 7 and FIG. 11. The transitional chains 9A and 9B pass freely through the transitional chain-locking mechanisms 3A, 3B, 28A and 28B as the magnetic brakes 12A, 12B, 27A and 27B hold the waiting wheels 2 or pushing walls 20 in place. The sprockets 3A-d and 3B-d of the transitional chain locking mechanisms 3A, 3B, 28A and 28B can be open and allowed to turn freely when a pair of brake magnets 12A, 12B, 27A and 27B is on and holding that wheel 2 or wall pair 20. When the magnets 12A, 12B, 27A and 27B are turned off, the sprockets 3A-d and 3B-d of the transitional chain lock mechanisms 3A, 3B, 28A and 28B will lock and the wave wheel 2 or pushing walls 20 assemblies will move with the transitional chains 9A and 9B again. Single sprockets 5A-g, 5B-g, 6A-g and 6B-g for the double chains 9A, 9B, 10A and 10B will be paired with rollers 5A-h, 5B-h, 6A-h and 6B-h to allow wave wheel sprockets 4A and 4B to mesh with each side of the double chains 10A and 10B as they pass each other FIG. 6, FIGS. 13-15.

### Sensors:

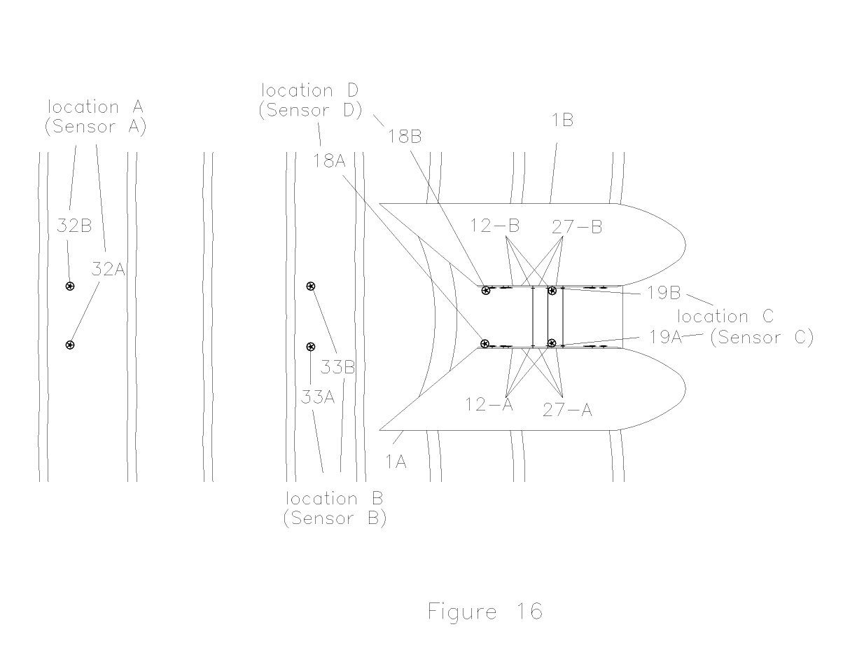

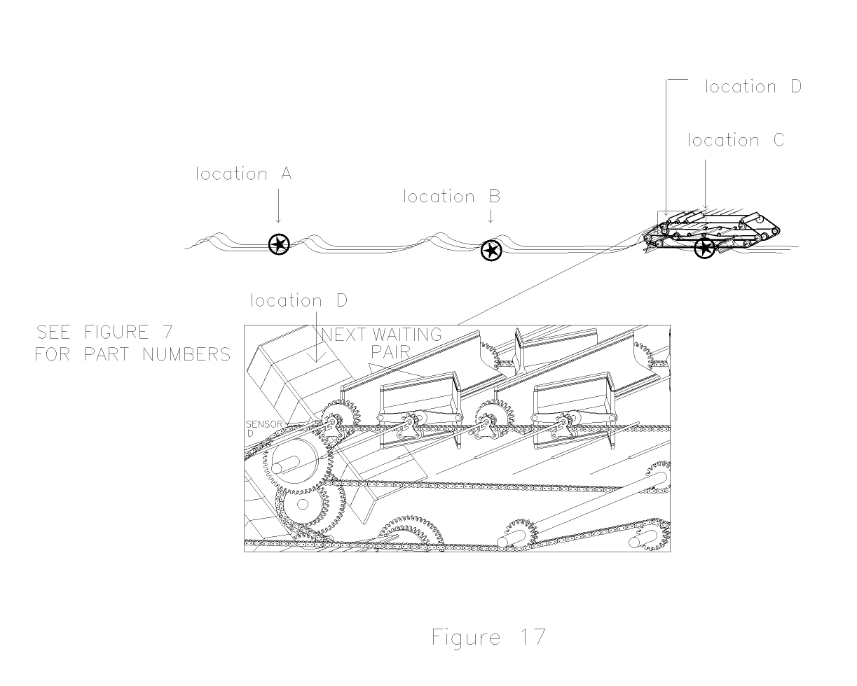

### INDEX FOR FIGS. 16 AND 17

1A and 1B Ship Hulls
12A and 12B Magnetic Brakes for Wave Wheels 2
18A and 18B Sensor D at Location D Mounted on the Sliding Walls 22A and 22B
19A and 19B Sensor C at Location C Mounted on the Sliding Walls 22A and 22B
27A and 27B Magnetic Brakes for Push Walls 20
32A and 32B Sensor A at Location A (Remote Bobbing Wave Detectors)
33A and 33B Sensor B at Location B (Remote Bobbing Wave Detectors)

Sensors 33A, 33B, 32A and 32B to detect both the amplitude and the period of the waves can be mounted in a position to detect this information from each wave before it reaches the wave energy-collecting device. A bobber mechanically attached to a potentiometer 33A, 33B, 32A and 32B can send a signal voltage proportional to the size of the next wave. The greater the displacement of the bobber, the greater the signal voltage sent to the extending mechanisms inside the paddles of each wheel 2 of extension of each set of push walls 20. This signal voltage can determine how far each waiting wheel-walls pair 2 and 20 can extend itself as it is released by the last two pairs of magnetic brakes 12A, 12B, 27A and 27B and passes though the engagement zone to meet the ocean surface. The distance can make each wheel-walls pair 2 and 20 meet the ocean surface in the trough in front of each approaching wave. Because the “next waiting pair” 2 and 20 is dependent upon one or more pair of pushing walls 20 remaining in the energy-gathering zone pulling the transitional chains 9A and 9B far enough to meet in front of the next incoming wave, another sensor 19A and 19B can be utilized. When the newest wave wheel 2 to enter the energy-gathering zone approaches this limiting point 19A and 19B, the magnets 12A, 12B, 27A and 27B can be triggered off to ensure continued motion of the transitional chains 9A and 9B.

The transitional chains 9A and 9B are driven by, and can move at the speed of, the waves in the energy-gathering zone. A sensor, or pair of sensors 33A and 33B, can be placed a distance in front of the wave collection device equal to the chain length from the second to the last pair of magnetic brakes 27A and 27B to the point the wave can hit the next pair of pushing walls 20 that came down from the waiting position. When an upcoming wave triggers the sensor 33A and 33B, all magnets 12A, 12B, 27A and 27B can be turned off for a brief time interval. This allows the next waiting pair 2 and 20 to advance though the engagement zone as the paddles and walls of 2 and 20 are expanded to fit the wave amplitude. Other wheel-walls pairs 2 and 20 in the waiting zone can advance to the next waiting position. The magnetic brakes 12A, 12B, 27A and 27B can be wired such that each two pair of magnets 12A, 12B, 27A and 27B that are occupied by a waiting wheel-walls pair 2 and 20 and the next unoccupied two pair of magnets 12A, 12B, 27A and 27B can be turned on in time for the wave wheel 2 to take the place of the wheel 2 ahead of it; and the pushing walls 20 to take the place of the pushing walls 20 ahead of it. This is so that the next wheel-walls pair 2 and 20 being pulled through the waiting zone by the transitional chains 9A and 9B can be caught by the last two unoccupied pair of magnetic brakes 12A, 12B, 27A and 27B. The exact placement of the sensors 32A, 32B, 33A and 33B for wave presence, speed, amplitude, and period, along with the logic of when the magnets 12A, 12B, 27A and 27B are turned off may be determined by experiment with a prototype. The amount of resistance in the transitional and rotational drive systems, turning the generators, can also be determined by empirical experimentation with a prototype. Both of these transmissions can vary in gear ratio to maintain a working balance under varied conditions. Certainly a low enough resistance to transitional motion of the waves can ensure continued motion of the transitional chains 9A and 9B and to keep each wave peak from passing its matched wheel walls pair 2 and 20.

In order for the wave collection mechanism to respond to the varying conditions of ocean waves, several sensors can be utilized. Three pairs of sensors can be placed in front of and beside the wave collection mechanism FIG. 16. The first pair the waves pass can be at location A, the second pair of sensors can be at location B, and the third pair at location C.

The sensors at location A, 32A and 32B can consist of a buoy coupled with a potentiometer, and an electronic counter. The potentiometer can determine wave amplitude and can send a voltage stored electronically in each waiting walls wheel pair 2 and 20. This can determine the amount of paddle extension in each wave wheel 2, and wall extension in each set of push walls 20, to match the size of the wave that wheel walls pair 2 and 20 is matched with. The contraction of the paddles in the energy collection zone as the wave becomes smaller can be automatically timed and based upon experiment. Such buoys that detect all of this information from the waves that pass under them have been in use by scientific organizations such as NOAA for years.

All automated controls in both the sensors 32A, 32B, 33A, 33B, 19A, 19B, 18A and 18B and inside the wave wheels 2 and push walls 20 can have the capacity to be overridden manually when needed. The sensors at locations A 32A and 32B, and B 33A and 33B, can contain electronic counters. When first set into operation, one wave can be followed visually and the counters at locations A and B reset to zero manually as the same wave passes each. A set minimum change in potential representing wave amplitude by the movement of the buoy can be counted in the counter as a wave. Each time a wave passes location A or location B, 1 is added to its respective counter. Each time a wave passes location B, 1 is subtracted from the counter at location A. Each time a wave, or wave wheel passes location C, 1 is subtracted from the counter at location B. As a result, the number in the counter at location A can equal the number of waves between location A and location B; and the number in the counter at location B can equal the number of waves between locations B and C.

Both location B and location C can control the switch that turns off the magnets to allow the wheel-walls pairs 2 and 20 to advance along with the transitional chains 9A and 9B. Whether the control of the off switch for the magnets is triggered at location B or location C can be determined by the following logic.

If the counter at location B reads less than 2, then the trigger to turn off the magnets is active at location C and inactive at location B. If the counter at location B reads greater than or equal to 2, then the “magnet off” trigger at location C is inactive. If the counter at location A reads greater than 1, then the “magnet off” trigger B is active. If location C turns the magnets off, it can become inactive until a wave passes location B and other stated conditions are met.

Location C is before the critical point (FIG. 16). The critical point is the minimum amount of distance in the energy collection zone required to bring the next wave walls pair 2 and 20 down to the water to be in position for the incoming wave. Location B can be such that when a passing wave triggers the magnetic brakes 12A, 12B, 27A and 27B to turn off, the next set of push walls 20 can meet the water in the trough just in front of the oncoming wave. Locations A and C can be equidistant from and on either side of location B.

Location C can detect the presence of passing wave wheels 2. An electric eye, magnetic or physical trip switch can serve as a sensor 19A and 19B. Another pair of sensors 18A and 18B can be placed at the position of the last pair of magnetic brakes 12A and 12B. This can be location D. When the magnets 12A, 12B, 27A and 27B are turned off from location B or C, the sensors 18A and 18B at location D can detect when the next walls wheel pair 2 and 20 have moved to the next pair of magnets and turn the magnets back on.

Each magnetic brake 12A, 12B, 27A and 27B in the waiting zone operates on the same type of part assembly each time it is turned on or off. Along in a row in the waiting zone in FIG. 5, FIG. 7 the magnetic brakes 12A, 12B, 27A and 27B alternate in function. From left to right, the first pair 12A and 12B are always used on a wave wheel 2; the second pair can be used on push walls 27A and 27B; the third pair 12A and 12B can be used on a wave wheel 2 and so on. One of many possible ways to ensure that each brake stops the part it was designed to stop and stops that part only is to add a sensor to every magnetic brake. Alternative magnetic brakes can have a different type of sensor. The sensors of the magnetic brakes that act upon a wave wheel assembly can be a type one sensor and those that cause the magnet to stop a wave walls assembly can be referred to as a type 2 sensor. See FIG. 17. The magnetic brakes with type 1 sensors are designated as part number 12. The magnetic brakes with type 2 sensors are designated as part number 27. The part of each wave wheel assembly or wave walls assembly that the magnetic brakes and sensors act upon is the chain lock mechanism detailed in FIG. 11. A material or reflector can be added to the chain lock mechanisms of the wave walls assemblies. The chain lock mechanisms with the reflector are referred to as part number 28 and the chain lock mechanisms with the reflector absent are referred to as part number 3. Part number 12, equipped with a type 1 sensor can remain on in the absence of a reflector and can act upon part number 3. Part number 27, equipped with a type 2 sensor can remain on in the absence of a reflector and can act upon part number 28.

Transmission:

The transmissions of the driving shafts to the electric generators (unshown) can consist of gears, torque converters, clutches, belts and pulleys and other parts that make up a mechanical transmission. The mechanical transmissions that link the rotation of the driving axles assemblies 21, 26A and 26B to the electric generators can be variable in torque and speed ratios. Both the rotational and transitional transmissions can be adjustable to provide optimum electricity production by the generators for the captured wave energy as it varies at any given time. The weight of all of the machinery of the transmissions and generators of the wave energy transfer and the tidal energy transfer from 14 and 15 can be distributed for proper buoyancy, as in any ship.

The transmission in this device can be designed to take maximum efficiency of varying conditions. Wave size, speed and period can vary along with degree of the rise and fall of the tide. Whether or not the tide is harnessed to turn generators through machinery can depend upon the scale at which the device is created. Either way, the multiple anchors 13 and cables 14 can help guide the waves between the ship hulls 1A and 1B as opposed to the ship hulls 1A and 1B riding over the waves. A dense ring, mounted to rotate with minimal friction, for example made of lead, can be incorporated in the transmission to store energy as inertia, to smooth out the operation of the system in the manner of a flywheel, and to allow the system to turn a maximum number of electrical generators depending on the speed and energy converted from the wave energy. There can be separate inertial rings for the rotational, transitional and tidal transmissions. The mass, friction and moment of inertia of each ring can be constant and the gear, sprocket, or pulley ratios that drive the ring can be determined by the speed of the ring. The driving gears can be mounted to a ratcheted sleeve on a shaft so that if the speed of the ring ever exceeds the driving gear, the gear will turn freely and not force the ring to slow down. The energy of each ring can be directly proportionate to its speed and each ring can drive a maximum number of generators depending on its speed. The inertial rings can stabilize the energy to rotate the generators at a desired speed, say 60 Hertz (US and Canadian Standard AC). The resistance to motion of the rotational and transitional motion that drives the transmissions can be balanced with one another to achieve smooth mechanical motion. If a non-discrete function of driving ratio is needed, a high friction roller of perhaps synthetic rubber driving a cone can achieve this. The surface of the cone can be coated or have a rough pattern to increase it's friction with the driving roller. The diameter of the part of the cone being driven by the roller can determine the gear ratio.

Uses for this Device

The portability of this electricity producing ship is one of its greatest assets. In FIGS. 3,4 and 16 the shape of the ship hulls are drawn such that the bow will be shaped hydrodynamically for transport; and the stern can be shaped to take best advantage of the Superposition Principle. Wherever the ship was built, it can be transported and put to use anywhere on the oceans of the world. Potentially dangerous waves or storms can be avoided instead of hopefully endured. Assuming that the electricity can be sent to supply a grid on shore via undersea cable 11 FIG. 3, the drilled in permanent anchors 13 and the power cable 11 can be reattached to, and reused as needed. Given the forces of tension the anchoring cables 14 can put on the anchors 13, drilling them into the ocean floor will be necessary. Ships in use currently used to drill for oil or to place pylons for bridges or piers can be used for this purpose. Each of these permanent anchors can also be equipped with GPS, sound or electromagnetic wave transmitting device to allow easy detection for anchoring cables to be reattached to for repeated use.

Electricity-producing plants harnessing wave power in use today transport electricity to shore via an electric cable 13 on the bottom of the ocean as in FIG. 3. A new type of lithium-ion battery developed in 2008 by Gerbrand Ceder at MIT has a higher capacity and charges and discharges faster than any other previously devised electric battery. A one-liter battery using this new chemistry can deliver 25 kW. A fleet of several ships using a large array of these new type batteries, along with a discharging dock can replace an ocean bottom cable 11 to shore, although the invention is not so limited, and any means of transmission of the generated power is within the scope of the invention.

This electricity-producing ship can be used to power a separate vessel to separate water molecules into hydrogen and oxygen. Pure oxygen has many uses in industry and medicine. Highly flammable hydrogen is a potentially valuable fuel source for internal combustion engines among other things. Water molecules are separated into hydrogen and oxygen by passing an electric current trough the water. Hydrogen bubbles from the cathode and oxygen bubbles from the anode. Ocean water containing salt (NaCl) is also a better conductor of electricity than fresh water. This ship can also be used to power a desalinization plant where fresh water is needed.

Possible Design Alternatives

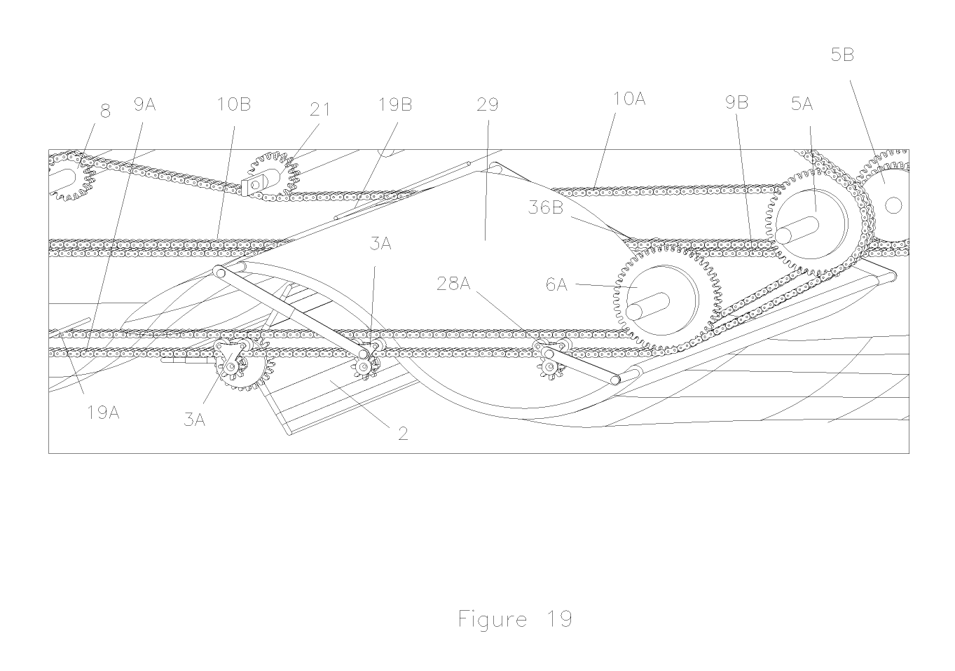

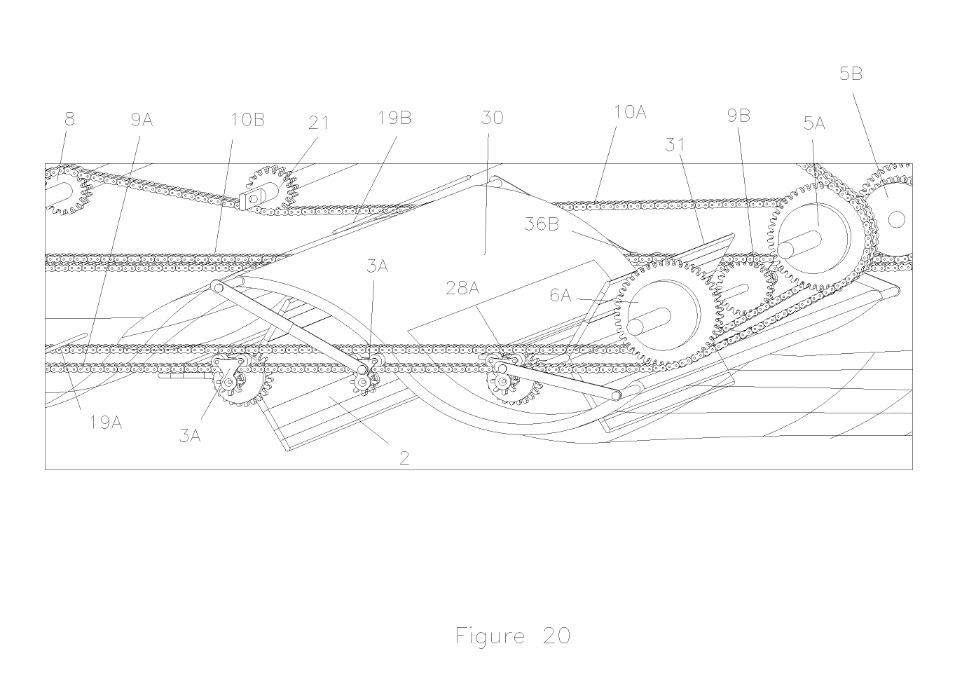

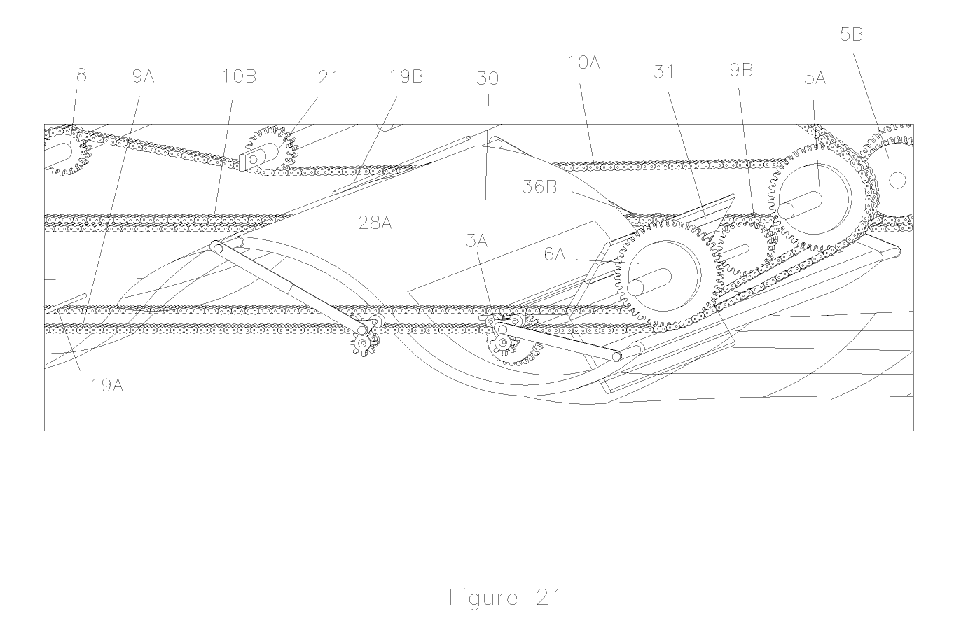

FIGS. 19-21 depict three other possible designs for the wave wheels and wave walls. FIG. 19 shows another possible push wall assembly design 29. FIG. 20 shows yet another design for the push wall 30 with a narrower second wave wheel assembly 31 incorporated. FIG. 21 is the same as FIG. 20 with the original wave wheel removed. These alternative designs would likely require a different spacing between the magnetic brakes 12A, 12B, 27A and 27B and placement of the sensors 33A, 33B, 19A and 19B at locations B and C

While the invention has been described with reference to preferred and example embodiments, it will be understood by those skilled in the art that a variety of modifications, additions and deletions are within the scope of the invention.

What is claimed is:

1. A method for generating electrical power from water waves comprising rotational and translational motion, said method comprising the following steps:
guiding at least one water wave through an energy collection mechanism secured within a channel defined by two walls, wherein the energy collection mechanism is positionable to face perpendicularly to the wave motion;
effecting a forward and circular motion of at least one wheel coupled with respect to an interior passageway in the energy collection mechanism, wherein the forward and circular motion of the at least one wheel is effected by the rotational and translational motion of the at least one water wave; and
converting the forward and circular motion of the at least one wheel into electrical energy with an energy converter.

2. The method of claim 1, further comprising storing the converted energy in an energy storage device coupled to the energy converter.

3. The method of claim 1, wherein the at least one wheel comprises at least two planar members extending outwardly from an axis, wherein the forward and circular motion of the wheel is effected by the force of the wave contacting the at least two planar members.

4. The method of claim 3, wherein the at least one wheel is rotatably secured around an axle movably mounted within the energy collection mechanism.

5. The method of claim 1, wherein the at least one wheel comprises at least one chain sprocket removably travelling along the links of at least one chain secured within the energy collection mechanism.

6. The method of claim 1, wherein the two walls comprise ship hulls floating above and below the wave trough line.

7. A system for adapting a buoyant structure to varying water wave conditions, the system comprising:
at least one cable anchored to the ocean floor and secured within a rotating tensioner mounted to the buoyant structure; and
at least one telescoping piston secured to the buoyant structure and extending to the ocean floor.

8. The system of claim 7, wherein the telescoping piston comprises a plurality of interlocking members, wherein each interlocking member comprises a compressible hydraulic piston having pressurized hydraulic fluid therein.

9. The system of claim 8, further comprising at least one electric generator operatively engaged with the at least one hydraulic piston.

10. The system of claim 9, wherein pressurization of the hydraulic fluid drives the at least one electric generator.

11. The system of claim 7, wherein the rotating tensioner is connected to an electric generator via a drive train transmission activated by tensile release of the at least one cable from the rotating tensioner.

12. A water wave wheel for contacting a water wave having a variable amplitude, the water wheel comprising;
a circular axis; and
a plurality of extendable paddles extending outwardly from the circular axis, wherein the length of each retractably extendable paddle adjusts with respect to the amplitude of a water wave.

13. The water wave wheel of claim 12, wherein each paddle retracts toward the circular axis in response to a decrease in wave amplitude.

14. The water wave wheel of claim 12, wherein each paddle extends away from the circular axis in response to an increase in wave amplitude.

15. The water wave wheel of claim 12, wherein each paddle mechanically extends and retracts.

16. The water wave wheel of claim 12, wherein at least one sensor communicates a signal to a control system for actuating the mechanical extension and retraction of the paddle in response to a wave characteristic.

17. A system for enhancing water wave amplitude comprising:
a pair of buoyant guiding walls angled toward each other at an end of each wall;
a plurality of anchors secured to the ocean floor;
a plurality of cables secured to the anchors;
a plurality of rotors secured with respect to the buoyant guiding walls, wherein the cables are wound about the rotors.

18. The system of claim 17, wherein the rotors are rotationally actuated to maintain tension in the cables.

19. The system of claim 18, wherein the length of the cables extending from the rotor is affected by the buoyant guide walls; wherein the buoyant guide walls move with respect to wave amplitude.

20. The system of claim 17, wherein the buoyant guide walls are ship hulls.

21. A method for capturing energy from water waves comprising rotational and translational motion and variable amplitude, the method comprising the steps of:
providing a pair of buoyant guide walls comprising an energy collection mechanism secured between the buoyant guide walls;
orienting the buoyant guide walls so that the energy collection mechanism perpendicularly faces oncoming water waves;
securing the pair of buoyant guide walls to the ocean floor with a plurality of cables;
supporting the pair of buoyant guide walls with a plurality of telescoping pistons extending from the buoyant guide walls to the ocean floor; and
ensuring that the guide walls extend below a trough line of the water waves.

22. The method of claim 21, wherein each cable is secured to the buoyant guide walls with a tensioning mechanism that releases and retracts the cable in accordance with the amplitude of a water wave.

23. The method of claim 22, further comprising an electric generator driven by tension created in the cable.

24. The method of claim 21, wherein each telescoping piston comprises a plurality of interconnecting members comprising internal hydraulic pistons.

25. The method of claim 24, further comprising an electric generator in operative engagement with the plurality of hydraulic pistons, wherein hydraulic pressure from the hydraulic pistons drives the electric generator.

26. The system of claim 21, further comprising the steps of:
effecting a forward and circular motion of at least one wheel coupled with respect to an interior passageway in the energy collection mechanism, wherein the forward and circular motion of the at least one wheel is effected by the rotational and transitional motion of the at least one water wave;
converting the forward and circular motion of the at least one wheel into electrical energy with an energy converter;
storing the converted energy in an energy storage device secured with respect to the at least one wheel.

27. The method of claim 26, wherein the at least one wheel comprises at least two planar members extending outwardly from an axis, wherein the forward and circular motion of the wheel is effected by the force of the wave contacting the at least two planar members.

28. The method of claim 27, wherein the at least one wheel is rotatably secured around an axle movably mounted within the energy collection mechanism.

29. The method of claim 26, wherein the at least one wheel comprises at least one chain sprocket removably travelling along the links of at least one chain secured within the energy collection mechanism.

30. The method of claim 21, further comprising utilizing power produced by the energy collection mechanism for an operation selected from hydrogen generation, oxygen generation, battery charging, desalinization of saltwater, and delivery of electricity to a power grid.

31. A system for converting water wave energy to electricity, the system comprising:
at least one water wave wheel having paddles rotatable about an axis;
at least one sensor for generating a signal responsive to a wave characteristic; and
a control system receiving the signal from the at least one sensor and actuating an operation of the water wave wheel responsive to the wave characteristic.

32. The system of claim 31, wherein the wave characteristic sensed by the sensor is selected from wave presence, wave speed, wave amplitude, and wave period.

33. The system of claim 31, wherein the paddles of each water wave wheel are extensible and wherein the operation of the water wave wheel responsive to the wave characteristic is an extension of the paddles responsive to wave amplitude.

34. The system of claim 31, further comprising a plurality of water wave wheels and a release mechanism for sequentially releasing the water wave wheels for engagement with successive waves, wherein the operation of the water wave wheel responsive to the wave characteristic is a triggering of the release of a water wave wheel responsive to wave presence.
